(19) United States
(12) Patent Application Publication
(10) Pub. No.: US 2008/0187130 A1
(43) Pub. Date: Aug. 7, 2008

(54) Cross-Connect Arrangement and Switch Matrix

(76) Inventors: Sture Roos, Mongagua (BR); Johan Oberg, Stockholm (SE)

Correspondence Address: ALBIHNS STOCKHOLM AB, BOX 5581, LINNEGATAN 2, SE-114 85 STOCKHOLM; SWEDENn, STOCKHOLM, omitted

(21) Appl. No.: 10/557,366

(22) PCT Filed: May 18, 2004
(86) PCT No.: PCT/IB2004/050739

§ 371 Date: Jan. 15, 2007

(30) Foreign Application Priority Data
May 19, 2003 (SE) 0301439-6

(51) Int. Cl. H04M 1/00

(52) U.S. Cl. 379/422

(57) ABSTRACT

The present invention relates to a switch matrix for making cross-connects for telephone lines. The switch matrix is comprised of a plurality of switch components (1) that include a plurality of input lines (A, B . . . ), a plurality of output lines (a, b . . . ), in which all of the output lines are commonly connected to the switch components, and drive means (3) and contact blocks (2) for selectively cross-connecting any one of the first switch component (1) input lines (A, B . . . ) to any one of the output lines (a, b . . . ). According to an embodiment, the invention comprises a switch component (4) that is arranged perpendicularly with respect to the first switch components (1), and a further switch component (6) is arranged in parallel with the first switch components and are connected the output lines (a, b . . . ). Furthermore, the input lines (A, B . . . ) connected to the first switch component (1) are also connected to inputs of the perpendicularly oriented switch component (4), whereby the output line (5) of switch component (4) is commonly connected to all the lines going into the further switch component (6).

### FIELD OF INVENTION

The present invention relates to a switch matrix for making cross-connections for telephone lines and, more particularly, to a switch matrix comprising a plurality of switch components operated by a drive mechanism

### BACKGROUND

In a switch matrix for making cross-connects within a telecommunications network using a drive mechanism to connect a plurality of cross-connect points, for example, in a rotary type switch, a failure of the drive mechanism will result in several cross-connect points being inaccessible for making connections. If these cross-connect points are oriented towards a telephone line, the line will not be able to be switched over. The problem can sometimes be corrected by orienting the switch in the other direction; however, in the above case the desired function cannot be applied in the line direction. However, it is possible to design a break or disconnect line function into the example accordingly.

There is a need to provide cross-connect redundancy in switch matrices to enable the switch matrix to continue to operate when the drive mechanism fails. There are various known means by which to switch copper lines in a telephone network, such as using electromechanical relays or robotic pick-and-place solutions that places conductive pins in holes to make the cross-connect. However, none of the prior art solutions have redundancy capability, i.e. the cross-connect in the switch matrix cannot be switched over to a backup when there is a failure.

### SUMMARY

An object of the present invention is to provide a solution for the aforementioned redundancy problem and provide a switch matrix that will continue to be operable in the event of a failure. The invention provides the addition of redundancy functionality to a switch matrix.

The invention relates to a switch matrix arrangement that comprises a plurality of switching components. The components are oriented in the input line direction whereby the cross-connect is made by means of the switch component in the line direction. Another backup or redundant switch component, oriented in the opposite direction, is connected to the plurality of switching components whereby in case of a failure in any of the switch components, the lines are always accessible.

The redundant component is connected to a further switch component in the line direction and is connected to the switching network's output lines. In this way all outputs can be accessible. This arrangement eliminates the need for extra line or cable pairs to be provided. This is important because in some cases a cable with additional pairs is required.

This invention functions relatively straightforwardly, reliably, and requires no additional cabling.

### BRIEF DESCRIPTION OF THE DRAWINGS

FIGS. 1-3 illustrate schematically the principle of the invention.

### DESCRIPTION OF THE INVENTION

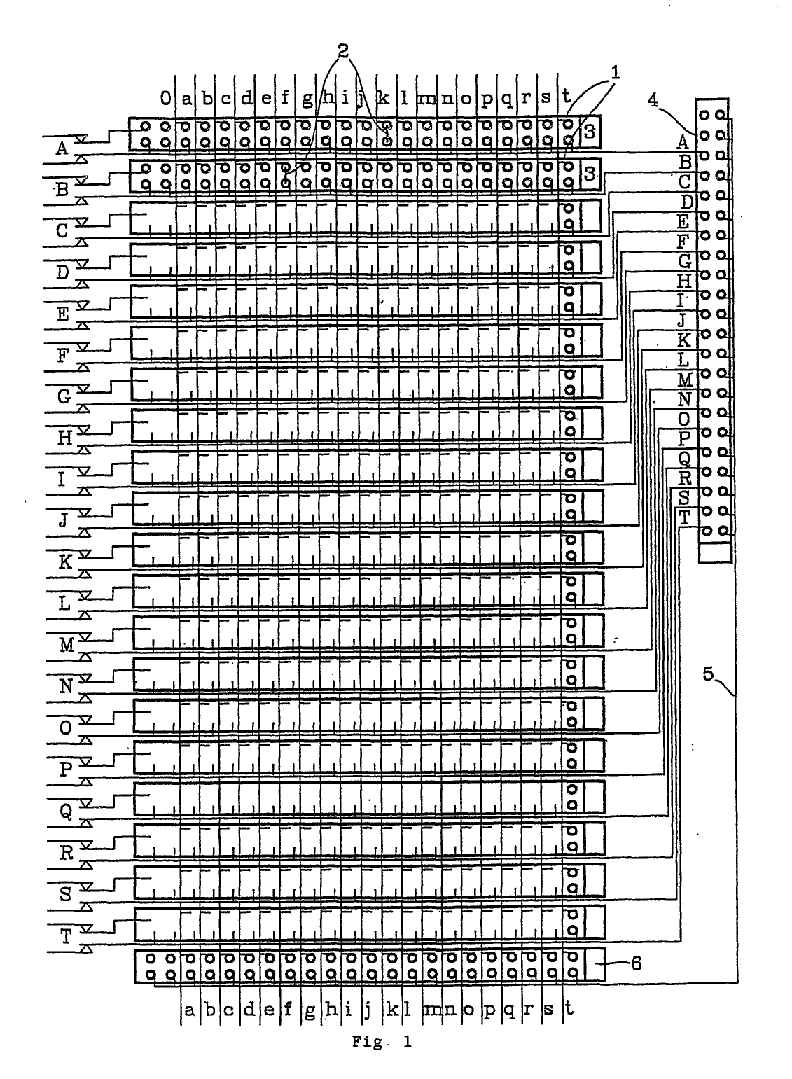

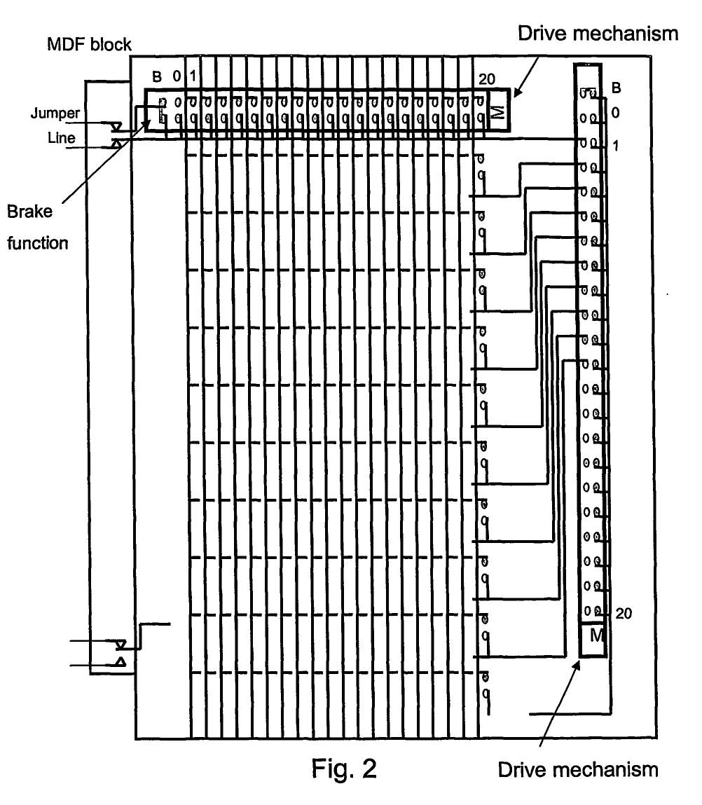

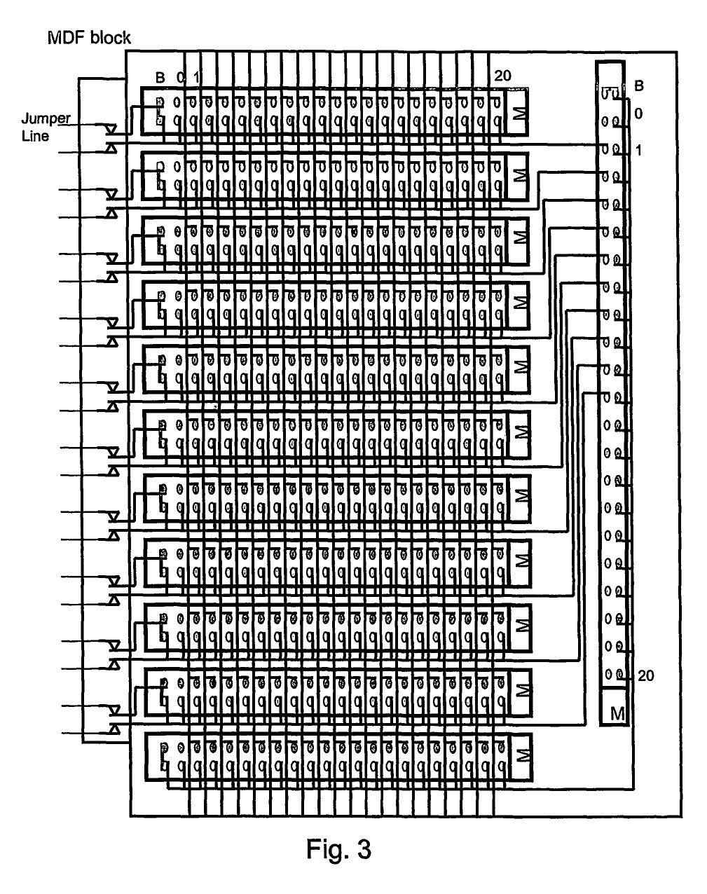

The figures show the principle of the invention. A switch matrix with a plurality of switch components 1 are arranged on a PCB. The matrix can be designed for accommodating, for example, 20×20 lines, i.e. 20 switch components 1. Each component consists of a number of first contact points (20 in this example), located in a straight line and connected by an incoming line (A, B . . . T). Parallel to this row of contact points, that is another row of contact points, which are connected by outgoing line (a,b, . . . t). The corresponding contact point in each of the switch components is connected to the same outgoing line a, b, . . . t. A contact block or sledge 2 can move parallel to the contact point rows and connect an incoming line with a selected outgoing line via corresponding contact points. By way of example, as shown in FIG. 1, the incoming line A is cross-connected to the outgoing line k and line B is cross-connected to line f by cross-connects 2.

Only one line per line is shown in the figure for simplicity. In practice there are two lines per line making up a line pair, whereby the switch matrix includes double rows of contact points, connected to the second incoming line and the second outgoing line, respectively, and two mutually moveable contact blocks 2. Furthermore, each of the switch components can include two other rows of contact points with moveable contact blocks that move together with the earlier described two blocks. These latter mentioned contact points are connected by a common incoming line and outgoing lines respectively, which can be used for a positioning function, which can be useful in a cross-connect apparatus where one wishes to determine the line connections.

Referring to FIG. 1, the contact block 2 moves by means of a drive mechanism 3 or M. In the case where one of the driving mechanisms fail, the switch matrix cannot be used and the cross-connect will fall out. In accordance with and embodiment of the invention, this problem can be overcome by providing a switch component 4 oriented in another direction on the PCB. This makes it possible to be able to always connect any one of the incoming lines to any one of the outgoing lines in case of failure of one of the driving mechanisms 3 or M in the switch components 1.

By way of example, if switch component 1 for line G fails, the switch component 4 will be oriented so that the contact block makes contact over input G with output line 5, which provides a connection for the input in switch matrix 6 to one of the outputs a,b, . . . t in the switch matrix. Thus, line G can be redirected to any selected outgoing line despite a failure in switch component 1.

The invention may contain modifications that will occur to those skilled in the art and that such modifications and variations are within the scope of the invention which are only limited by the following claims.

1. A cross-connect arrangement for cross-connecting telephone lines, comprising:
a plurality of switch components (1,4,6) that include a par of first and second contact points, drive means (3), contact block means (2) that are arranged to cross-connect a selected pair of first and second contact points;
input lines (A, B . . . );
output lines (a, b . . . );
wherein
the first switch component (1) whose first contact points are connected to a respective first switch component (1) input line (A, B . . . ),
and wherein the second contact point in each pair of first and second contact points are connected to output line (a, b . . . ) that are commonly connected to said first switch component (1),
and wherein said first switch component (1) is arranged for connecting with respective switch component (1) input lines (A, B . . . ) with a selected output lines (a, b . . . ) from switch component (1) output lines (a, b . . . );
a second switch component (4) wherein first contact points are connected to input lines (A, B . . . );
a third switch component (6) whose contact points are connected to a second switch component (4) second contact points, and wherein the second contact points are connected to the output lines (a, b . . . );
and wherein said second switch component (4) and said third switch component (6) are arranged for connecting any one of a selected input lines (A, B . . . ) to any one of a selected output lines (a, b . . . ).

2. The cross-connect arrangement of claim 1, wherein said first switch components (1) pair of first and second contact points are arranged in a matrix structure having input lines (A, B . . . ) that are arranged perpendicularly to the output lines (a, b . . . ), wherein each pair of contact points are positioned at a cross point capable of cross-connecting the input lines (A, B . . . ) and the output lines (a, b . . . ).

3. The cross-connect arrangement of claim 2, wherein the first switch components (1) are arranged with parallel rows of contact points in the matrix structure.

4. The cross-connect arrangement of claim 3, wherein the second switch component (4) is arranged with a row of contact points that are perpendicular to the parallel rows of the contact points of the first switch components (1).

5. The cross-connect arrangement of claim 3, wherein the third switch component (6) is arranged with a row of contact points that are parallel with the parallel rows of the contact points of the first switch components (1).

6. A cross-connect arrangement according to claim 2, wherein:
the switch components are constructed as elongated components;
said first switch components (1) and said third switch component (6) is arranged parallel with respect to each other in the matrix structure; and
said second switch component (4) is arranged perpendicularly with respect to the first and third switch components (1,6).

7. A cross-connect arrangement according to claim 1, wherein:
the first switch components (1) are oriented in the line direction corresponding with the input lines (A, B . . . ) from a telephone line connected to the first contact points, and wherein the output lines (a, b . . . ) are connected to the second contact points;
the second switch component (4) is oriented opposite to the line direction with their first contact points being connected to the input lines (A, B . . . ) and the second contact points being connected to a common line (5); and
the third switch component (6) is oriented in the line direction in that the first contact points are connected to the common line (5) and with the second contact points being connected to the output lines (a, b . . . ).

8. A switch matrix for establishing cross-connects for telephone lines having redundant connections functionality, wherein the switch matrix comprises a first switch components (1) whose cross-connects are oriented in a first line direction with respect to the telephone lines and wherein the switch matrix comprises a plurality of input lines (A, B . . . ), a plurality of output lines (a, b . . . ), wherein the output lines are commonly connected to the first switch components (1), and drive means (3) and contact blocks (2) for selectively cross-connecting any one of the first switch component (1) input lines (A, B . . . ) to any one of the output lines (a, b . . . ),
wherein it comprises,
a second switch component (4) having connections that are oriented in a second line direction that is opposite with respect to the first switch component (1), and
a third switch component (6) having connections that are oriented in parallel with the orientation of the first switch component (1) and where the outgoing lines are connected to the output lines (a, b . . . ),
wherein the input lines (A, B . . . ) of the first switch component (1) are also connected to the ingoing lines of the second switch component (4), wherein the outgoing lines are commonly connected to the ingoing lines of the third switch component (6),
whereby the cross-connect between any one of the input lines (A, B . . . ) and any one of the selected output lines (a, b . . . ) can occur by means of the second and third switch components (4,6).

9. A switch matrix according to claim 8, wherein the switch components (1,4,6) are of elongated form and wherein:
the first switch components (1) and the third switch component (6) are arranged in parallel in the matrix; and
the second switch component (4) is arranged perpendicularly with respect to the first and third switch components.
